(19) United States
(12) Patent Application Publication
(10) Pub. No.: US 2024/0140204 A1
(43) Pub. Date: May 2, 2024

(54) CURRENT COLLECTOR AND METHOD FOR OPERATING

(71) Applicant: Schunk Transit Systems GmbH, Wettenberg (DE)

(72) Inventor: Daniel Pfeffer, Mücke (DE)

(21) Appl. No.: 18/280,789

(22) PCT Filed: Mar. 10, 2021
(86) PCT No.: PCT/EP21/56098

§ 371 Date: Sep. 7, 2023

(51) Int. Cl. B60L 5/38

(52) U.S. Cl. CPC B60L 5/38; B60L 2200/26

(57) ABSTRACT

A method for operating a current collector and a current collector are provided for transferring energy from a conductor rail to a rail vehicle. The current collector includes a contact pressing device having a sliding piece which forms a sliding contact surface. A contact pressing force acts on the sliding piece, as the sliding piece is moved relative to the conductor rail. The current collector further includes a measuring unit having a measuring device, at least one sensor of a sensing device of the measuring device being disposed on the contact pressing device and/or adjacent to the contact pressing device. A measured value of the contact pressing device is registered by means of the sensing device. The measured value is processed by a processing unit of the measuring device and a parameter describing an operating state of the current collector and/or the conductor rail is determined.

### FIELD OF THE INVENTION

The invention relates to a current collector and a method for operating a current collector for transferring energy from a conductor rail to a rail vehicle, the current collector comprising a contact pressing device having a sliding piece which forms a sliding contact surface, a contact pressing force acting on the sliding piece, which is disposed on the rocker, being generated by means of a rocker unit having a pivotable rocker and by means of a spring device of the contact pressing device, the sliding piece being moved relative to a conductor rail by means of the rocker unit and, for forming a sliding contact, being pressed against the conductor rail in a sliding contact position using the contact pressing force.

### BACKGROUND OF THE INVENTION

Current collectors and methods of this kind are well known from the state of the art and are commonly used on rail vehicles for transmitting electrical energy from a conductor rail to a rail vehicle. The conductor rail is usually disposed in the area of the guide rails and is commonly referred to as the so-called third rail. In the known current collectors, a sliding piece is disposed on a rocker arm or on a guide which is formed by articulations and which serves to mount and move the sliding piece relative to the conductor rail. By means of this mechanical suspension of the sliding piece, the sliding piece can be pressed against a sliding contact surface of the conductor rail using a defined contact pressing force. A distinction is made between conductor rails or current collectors where the sliding piece pressed against a topside of the conductor rail, an underside of the conductor rail or a lateral surface of the conductor rail. By driving or by moving the sliding piece onto the conductor rail, the sliding piece is contacted by the conductor rail via a start ramp, the rocker arm or rocker or articulation guide then being pressed back by via the sliding piece and thus, the necessary contact pressing force being generated by the spring device. The spring device can be formed as a mechanical torsion spring, coil spring or rubber spring.

The spring device also offsets movements of the rail vehicle and a varying course of the conductor rail. Depending on the mounting position on the rail vehicle, a relative distance between current collector and conductor rail can be changeable in accordance with a load situation of the rail vehicle. For example in the area of switches or connectors, start ramps for the sliding piece are provided or there can be ledges having a height difference of several centimeters. Rail vehicles regularly drive on these route sections at a comparatively high speed, whereby the respective sliding piece is subject to a strong impact, in particular because of ledges in the conductor rail. In this case, the sliding piece can even lift off the conductor rail and jump on the conductor rail because of vibrations on the conductor rail, whereby the material of the sliding piece is heavily stressed. The sliding piece itself or the rocker can also be caused to vibrate by means of the spring device. When the sliding piece lifts off the conductor rail, electric arcs may be caused, as a result of which the rail vehicle requires more energy. Furthermore, the mechanical suspension of the sliding piece is stressed more. The sliding piece also becomes worn from electrical wear. Overall, this results in an increased effort for carrying out maintenance on the current collector and for replacing the sliding piece. Current collector of this kind are known from DE 10 2009 054 484 B4 and US 2013/0081915 A1, for instance.

### SUMMARY OF THE INVENTION

Therefore, the object of the invention is to propose a method for operating a current collector and to propose a current collector and a monitoring system having a current collector which allows an improved operation.

This object is attained by a method having the features of claim 1, by a current collector having the features of claim 17 and by a monitoring system having the features of claim 18.

The method according to the invention for operating a current collector for transferring energy from a conductor rail to a rail vehicle is carried out by a current collector which comprises a contact pressing device having a sliding piece which forms a sliding contact surface, a contact pressing force acting on the sliding piece which is disposed on the rocker being generated by means of a rocker unit having a pivotable rocker and by means of a spring device of the contact pressing device the sliding piece being moved relative to a conductor rail by means of the rocker unit and, for forming a sliding contact, being pressed against the conductor rail in a sliding contact position using the contact pressing force, the current collector comprising a measuring unit having a measuring device, at least one sensor of a sensing device of the measuring device being disposed on the contact pressing device and/or adjacent to the contact pressing device, a measured value of the contact pressing device being registered by means of the sensing device, the measured value being processed by means of a processing unit of the measuring device and a parameter describing an operating state of the current collector and/or the conductor rail being determined.

The rocker unit of the contact pressing device is formed so as to be rotatable, so that the unloaded rocker having the sliding piece attached thereto can be moved from an end position to the sliding contact position on the conductor rail while generating a contact pressing force. In this case, the contact pressing force is exerted by the spring device. Thus, the rocker unit allows only a movement of the sliding piece or the rocker between the sliding contact position and the end position. The rocker can be mounted on a simple swivel so as to be rotatable or be formed by a plurality of swivels which are mounted on one pivot point each. The spring device can have a mechanical, pneumatic or hydraulic spring element which is suitable for exerting the contact pressing force.

The method according to the invention intends that the current collector comprises a measuring unit having a measuring device, said measuring device having a sensing device having at least one sensor. The sensor is disposed on the contact pressing device or the rocker or the sliding piece and/or adjacent to the contact pressing device or arranged as close as possible to the rocker or the sliding piece. A measured value of the contact pressing device or the rocker or the sliding piece is registered by means of the sensing device or the sensor. This measured value is a physical measured variable which is directly operably linked to the contact pressing device and which is variable during an operation of the current collector. Then, the measured value or measured variable measured by the sensor is processed by means of the processing unit and a parameter is determined which is suitable for describing an operating state of the current collector and/or the conductor rail. The parameter can be a parametric value, a characteristic variable, a key figure or a data set. The parameter can also be included in a data set. In particular, it is intended to digitally process the measured values by means of the processing unit in order to obtain a parameter that is suitable for further digital processing. Thus, the processing unit is formed by at least one digital electronic circuit which can process analogue and/or digital signals of the sensor. The processing unit can also be a programmable logic controller (PLC), an integrated circuit (IC) or a computer, for example.

As a result of the processing unit determining the parameter suitable for describing the operating state of the current collector, it becomes possible to determine the operating state of the current collector, to monitor the current collector and/or to influence the operating state of the current collector. Since the operating state of the current collector also largely depends on the state or operating state of the conductor rail, the parameter can also describe the operating state of the conductor rail. For example, the operating state can be a state of wear, so that it becomes possible to make a statement about the state of wear based on the parameter. Overall, maintenance on the current collector and the conductor rail can be carried out in a more targeted manner without having to adhere to regular maintenance intervals. Furthermore, it is also possible to implement operating state changes, for example by adjusting the contact pressing force. Overall, it thus becomes possible to operate a current collector or a conductor rail, and thus a rail vehicle, more cost-effectively in total.

As a measured value, an angular position of the rocker unit, an acceleration, a frequency, a temperature, an illuminance, a force, a current, a voltage, am electrical resistance, a distance, a mass, an air pressure and/or a location can thus be registered and processed continuously or discontinuously. Based on the angular position of the rocker unit, a deflection of the rocker relative to the rail vehicle can be measured at a pivot point of the rocker. For example a rotary potentiometer on the pivot point or another suitable sensor can be used for this. A temperature can be measured on the contact pressing device or directly on the rocker or the sliding piece using a temperature sensor, so that it can be determined, for example, whether the conductor rail is at risk of being frozen. A measurement of the illuminance can be carried out using an optical sensor or even a camera which then forms the sensor. Thus, irregularities on the surface of the conductor rail or electrical arcs can be determined. A force can be determined by means of a strain gauge, a force sensor, a pressure sensor or the like. For example, a contact pressing force can thus be measured. A current or a voltage can be measured using an ammeter or a voltmeter as a sensor. A resistance can be determined from the current and voltage and be a measure for a contact quality and also make a statement about a state of wear of the sliding piece. For example, the quality of the energy transfer between the sliding piece and the conductor rail can then be determined. The mass can also be determined by means of a force sensor. The air pressure can be measured on a bellows or a pressure cylinder for generating the contact pressing force. A location of the current collector can be easily determined using a satellite navigation system, such as GPS. The measured value or the measured values can be determined or processed continuously or consecutively. It is also possible to register and process the measured value or measured values discontinuously, for example at set points in time or on certain occasions.

It is especially advantageous if at least one acceleration sensor, which can be disposed on the sliding piece and/or the rocker unit, is used as a sensor. The acceleration sensor or vibration sensor can be used for measuring an eigenfrequency and/or resonant frequency of the rocker unit or the entire current collector. For example, by means of the acceleration sensor, a movement of the sliding piece on the conductor rail can be detected, in which case conclusions regarding a design of the conductor rail can be drawn from the movement. Thus, a ledge in the course of the conductor rail, which can cause the sliding piece to lift off the conductor rail, can be easily determined. Special measurement drives or on-site inspections of the conductor rail for determining such defects are thus no longer necessary. Furthermore, a sliding piece change as a result of wear or abrasion on the conductor rail causes the eigenfrequency and/or resonant frequency of the sliding piece to change. The difference between a new and a worn sliding piece can result from this. Since the sliding piece is regularly in contact with the conductor rail during the drive of the rail vehicle, the processing unit can derive a change of the sliding piece from an eigenfrequency and/or resonant frequency change of the sliding piece. For example, the eigenfrequencies and/or resonant frequencies of new and worn sliding pieces can be stored in the processing unit, in which case the processing unit can make a comparison and determine a state of wear or the use of the sliding piece without further calculations. This wear can then be output in the form of the parameter. Furthermore, it can easily be determined whether the sliding piece is broken or deformed.

The processing unit can register and store the measured values of sensors and/or the parameters at regular time intervals, when a change occurs, or continuously. Accordingly, it can be envisaged that the measured values and/or the parameters are only registered and stored when the values change in order to minimize the amount of data. Alternatively, a continuous, in other words, a consecutive registration and storage can be intended. By storing the measured values and/or parameters, the processing can be carried out even after the registration. For example, measured values can be registered during a drive of the rail vehicle, in which case the determination of the parameter or the parameters can then be carried out once the rail vehicle is being inspected in a depot. In this manner, the condition of a conductor rail along a route of the rail vehicle can be determined after a drive, for example.

An actuator for actuation the rocker unit can be controlled by means of a control device of the measuring device, the actuation of the rocker unit being controlled according to a measured value and/or a parameter by means of a control mechanism of the control device. The contact pressing device can comprise the actuator which can be connected to the rocker unit or rocker in such a manner that by means of a linear movement of the actuator, the rocker unit can be pivoted between a sliding contact position and a storing position. The actuator can be formed by a linear drive or by a pneumatic or hydraulic cylinder. It can also be envisaged that the contact pressing force is changed by means of the actuator or that the actuator generates the contact pressing force. In this case, the actuator forms the spring device. The measuring device can then transmit signals or measured values and/or parameters to the control device and said control device can use them to control the rocker unit by means of the control mechanism. For example, if the processing unit detects that the sliding piece is broken, the rocker can be pivoted to a storing position on the rail vehicle. Furthermore, it is possible to control the contact pressing force via the actuator. In principle, a control device of this kind can also be provided as a module of the rail vehicle irrespective of the measuring device.

The contact pressing force can be controlled by the control mechanism in accordance with the measured values and/or parameters. For example, the contact pressing force can be generated so as to be essentially constant, irrespective of an angular position of the rocker and a movement of the rocker. Thus, the sliding piece can mostly be prevented from lifting off or jumping on the conductor rail as a result of irregularities on the conductor rail. For example, the processing unit can output a parameter to the control device after the sliding piece has been accelerated away from the conductor rail, the control device then being able to exert a counterforce onto the rocker by means of the control mechanism or the actuator, said counterforce preventing a lift-off. The contact pressing force can also be controlled such that the sliding piece is not excessively worn as a result of an increased contact pressing force. Thus, the contact pressing force can also be comparatively reduced, if an improved electrical contact with the conductor rail can be formed.

The measuring device can transmit the measured values and/or parameters to an evaluation unit, the measured values and/or parameters being storable in a database of the evaluation unit and/or being processable by means of an evaluation device of the evaluation unit. The evaluation unit can thus comprise the database and the evaluation device. Thus, the evaluation unit can serve to collect and process the measured values and/or parameters and can be a computer. For example, the evaluation device can display or output a result of an evaluation to an operator. The evaluation unit can have a larger range of functions than the processing unit. In principle, however, it is also possible to integrate the processing unit in the evaluation unit and vice versa. In principle, an evaluation unit of this kind can also be provided as a module of the rail vehicle irrespective of the current collector.

The measured values and/or parameters of the measuring device are transmittable to the evaluation unit and/or the control device via a data link by means of a transmitting unit of the measuring device, the evaluation unit and/or the control device being configured to be disposed at a distance to the measuring unit or integrated in the measuring unit. If the control device or the evaluation unit is integrated in the measuring unit, the data link can be formed easily by a line connection. It is then also possible to install parts of the measuring device, such as the processing unit and the control device and also the evaluation unit, elsewhere on the rail vehicle, for example on an operator's stand. When the measured values and/or parameters are transmitted, data can be exchanged on the basis of a transmission protocol, for example. The data link can be established continuously, at regular intervals or so as to be triggered by incidents. Overall, this allows to collect and evaluate the data collected by the measuring device. An analysis of certain conditions and incidents then provides various opportunities for evaluation, by means of which the operation of the current collector and the conductor rail or the rail vehicle can be optimized.

The data link can be formed via an external data network. In this case, the data link can be formed via a mobile network, a wireless network, a satellite connection, the internet or any other radio standard on its own or in combination. If the evaluation unit and/or the control device is disposed at a distance to the measuring unit, it can also be disposed outside of the rail vehicle, far away from the rail vehicle and so as to be stationary, for example in a building. In particular, it thus becomes possible to monitor and/or control a function of the current collector on the rail vehicle without a person having to perform this task on the rail vehicle itself.

A data link to the evaluation unit and/or to the measuring unit can be formed by means of a user unit, the measured values and/or parameters being transmittable and configured to be output to the user unit. The user unit can be a computer which is independent of the evaluation unit and/or the measuring unit. This computer can be a stationary computer, a mobile device, or the like, by means of which another data link for exchanging data with the evaluation unit and/or the measuring unit can be established. For example, the data can be exchanged via an external data network, such as the internet. In this manner, data processed by the evaluation unit or measured values and/or parameters processed using the evaluation device can be provided to a wider range of users. For example, the evaluation unit can be a server with a software which transmits the information stored in the database of the evaluation unit to the user unit. This transmission can take place since a website with selected information, such as a current state of wear of the sliding piece is provided.

The processing unit or the evaluation unit can evaluate a time curve of the measured values and/or parameters and determine a state of wear of the current collector and/or the conductor rail, taking into account a time-dependent component and/or a component depending on measured variables relevant for the wear. Thus, not only can information be provided regarding the current state of wear, it can even be determined at which point in time a sliding piece, for example, will approximately have become worn. Thus, a maintenance interval for the current collector can be scheduled precisely and the timing can be optimized. Furthermore, the point in time at which certain incidents took place can be determined by means of the time curve. On this basis, a scheme can be derived if incidents occur repeatedly. For example, a poorer electrical contact or an increased wear can be observed when driving on a certain section of the route.

A vibration of the sliding piece can be registered by means of the sensing device, the processing unit being configured to determine an eigenfrequency and/or a resonant frequency of the sliding piece and/or the rocker unit, the processing unit or the evaluation unit being configured to determine a state of wear of the sliding piece. The shape, in particular the height of the sliding piece can change when the sliding piece is worn, in which case the shape change can change the eigenfrequency and/or the resonant frequency of the sliding piece. A state of wear of the sliding piece and/or the rocker unit can be determined from the eigenfrequency and/or the resonant frequency by means of the processing unit. If the eigenfrequency and/or the resonant frequency changes as material is increasingly abraded from the sliding piece or from a component of the rocker unit, conclusions regarding the state of wear of the sliding piece and/or the rocker unit can be drawn from this change. Thus, it is not only possible to determine whether the sliding piece is new or completely worn, but also to what extent the sliding piece has been used.

The processing unit or the evaluation unit can carry out a pattern analysis of the measured values and/or parameters stored over a time period and derive a key figure from the pattern analysis. It can also be intended that the pattern analysis is carried out using artificial intelligence. The processing unit or the evaluation unit can correlate the measured values of different sensors and/or parameters and derive functional dependencies of the measured values and/or parameters. Thus, functional dependencies among the sensors can be examined. For example, a transmitted current can be compared to a temperature and thus, it can possibly be determined that a conductor rail is frozen. In this manner, a number of other operating conditions and incidents can be detected and interpreted as a result of functional dependencies, for example ramps along a conductor rail and their relative position, their inclination and quantity, a lift-off of the sliding piece from the conductor rail and, possibly, a spark formation or an electric arc, a wear of the sliding piece as a result of mechanical friction on the conductor rail or an electrical abrasion as a result of a contact pressure or the contact pressing force, in particular an averaged wear over a route, route sections with particularly high or particularly low wear, a wear rate depending on the driving behavior, such as an acceleration or standstill current load, damage and/or position deviations of the conductor rail, a current load, such as a temporary overcurrent, short circuit current, triggering a protective fuse or a short circuit in the event of an error, the condition of wear components of the current collector, such as bearings, joints and structural elements, loss of the sliding piece, for example as a result of a collision with an obstacle, a position, speed, acceleration and moving direction of the rail vehicle. These exemplary conditions and incidents can be addressed accordingly by maintenance measures, by adjusting the driving behavior of the rail vehicle or by implementing other suitable measures.

It can also be intended that the processing unit or the evaluation unit correlates signals or measured values of sensors and/or parameters which are not associated with the current collector and signals or measured values of sensors and/or parameters which are associated with the current collector. For example, by additionally taking into account signals or measured values and/or parameters of sensors of a ground contact, a pantograph, a wheel flange lubrication, a shaft grounding, etc.

A location of the current collector can be determined by means of a position sensor of the sensing device, the location being associated to the parameters, the evaluation unit being configured to determine a state of wear of the conductor rail. The position sensor can determined a position of the current collector and thus a position of the vehicle via satellite navigation, for example. Thus, it can be determined, inter alia, at which point of a route a certain measured value of another sensor of the sensing device has been registered. Thus, the corresponding location can be associated with an incident or a measured value. Furthermore, it is possible to determine the state of wear of the conductor rail by means of the evaluation unit, for example via an evaluation of the vibrations of the current collector or the rocker unit along the conductor rail. Thus, the vibration pattern of the rocker unit can change when the conductor rail is heavily worn. Furthermore, recesses, interruptions and ramps along the conductor rail can be determined and associated with a position on the route. This can have an influence on the speed of the rail vehicle in the sections of the route which have been localized in this manner.

The evaluation unit can process parameters of measuring units of a plurality of current collectors. Thus, the evaluation unit can process parameters of a plurality of current collectors which are disposed on individual rail vehicles. The accuracy of a measurement or a monitoring can be increased further by comparing the parameters of the current collectors. Furthermore, parameters of current collectors which are disposed on different rail vehicles can be processed by means of the evaluation unit. This can also significantly improve the accuracy of measuring and monitoring the rail vehicles or the respective conductor rails. Among other things, this provides a current and constantly changing status report on a route network and the vehicles operating in it. An optimization of the operating state resulting from this can significantly decrease operating costs. Monitoring the infrastructure and the rail vehicles regularly and frequently is also no longer necessary to this full extent and the operational safety is increased significantly. Furthermore, special measurement drives are no longer necessary.

The current collector according to the invention for transferring energy from a conductor rail to a rail vehicle comprises a contact pressing device having a sliding piece which forms a sliding contact surface, the contact pressing device comprising a rocker unit for generating a contact pressing force using a pivotable rocker and a spring device, the sliding piece being disposed on the rocker, the contact pressing device being formed such that the sliding piece is moveable relative to a conductor rail by means of the rocker unit, and, for forming a sliding contact, is configured to be pressed against the conductor rail in a sliding contact position using the contact pressing force, the current collector comprising a measuring unit having a measuring device, at least one sensor of a sensing device of the measuring device being disposed on the contact pressing device and/or adjacent to the contact pressing device, a measured value of the contact pressing device being registerable by means of the sensing device, the measured value being processable by means of a processing unit of the measuring device and a parameter describing an operating state of the current collector and/or the conductor rail being determinable. For further details on the advantages of the current collector according to the invention, reference is made to the description of advantages of the method according to the invention. Further advantageous embodiments of a current collector are apparent from the description of features of the dependent claims referring back to method claim 1.

The monitoring system according to the invention comprises at least one rail vehicle having at least one current collector according to the invention.

The monitoring system can have a plurality of measuring units and an evaluation unit for processing measured values and/or parameters of the measuring units of a plurality of current collectors. As described above, it thus becomes possible to monitor a plurality of current collectors of a rail vehicle or a plurality of rail vehicles having current collectors or to control the respective current collectors using only one evaluation unit.

Thus, the monitoring system can comprise a plurality of rail vehicles, each having at least one current collector. It can also be intended that the rail vehicles each have a plurality of current collectors.

Further advantageous embodiments of a monitoring system are apparent from the description of features of the dependent claims referring back to method claim 1.

### BRIEF DESCRIPTION OF THE DRAWING FIGURES

Hereinafter, the invention will be described in more detail with reference to the accompanying drawings.

FIG. 1 is a side view of a first embodiment of a current collector on a rail vehicle;

FIG. 2 is a side view of a second embodiment of a current collector on a rail vehicle;

FIG. 3 is a schematic view of a first embodiment of a measuring unit;

FIG. 4 is a schematic view of a second embodiment of a measuring unit;

FIG. 5 is a schematic view of a monitoring system.

### DETAILED DESCRIPTION

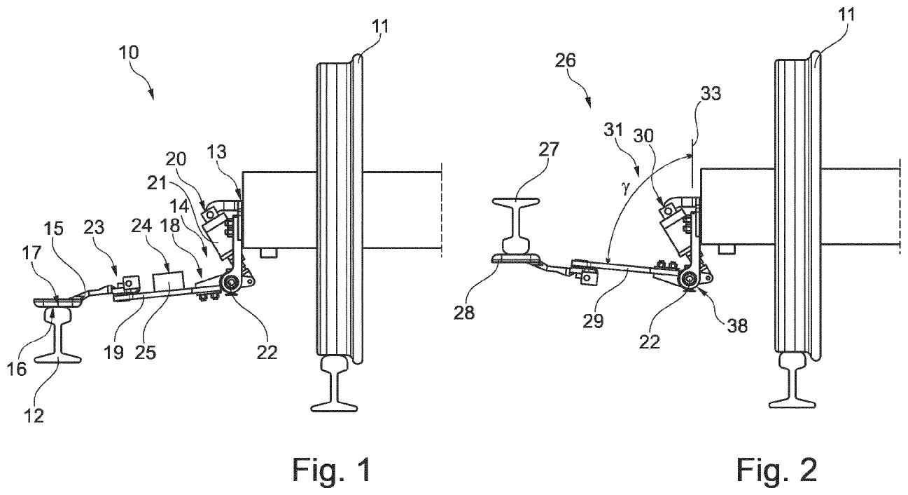

FIG. 1 shows a current collector 10 between wheels 11 of a rail vehicle (not further illustrated) on a conductor rail 12. Current collector 10 comprises a carrying device 13 and a contact pressing device 14 having a sliding piece 15. Carrying device 13 serves to mount current collector 10 on the vehicle (not further illustrated). Sliding piece 15 is connected to contact pressing device 14 and is in contact with conductor rail 12 in a sliding contact position as illustrated. A sliding contact surface 16 of sliding piece 15 then rests on an upper side 17 of conductor rail 12, so that an electrical contact is established between current collector 10 and conductor rail 12.

Contact pressing device 14 presses sliding piece 15 against conductor rail 12 using a contact pressing force, contact pressing device 14 comprising a rocker unit 18 having a pivotable rocker 19 and a spring device 20. Spring device 20 is connected to carrying device 13. Spring device 20 is formed by a spring (not further illustrated) which generates the contact pressing force. Furthermore, spring device 20 comprises an actuator 21 by means of which rocker 19 can be actuated or pivoted. Rocker 19 is mounted on a swivel 22 so as to be pivotable. Sliding piece 15 is mounted on a distal end 23 of rocker 19. By an actuation by means of actuator 21, it is now possible to pivot rocker 19 such that sliding piece 15 is removed from conductor rail 12 and brought to an essentially vertical position or storing position. Furthermore, a sensor 24, which is schematically illustrated in this case, is disposed on rocker 19. Sensor 24 is formed by an acceleration sensor 25. Sensor 24 is part of a sensing device (not further illustrated) of a measuring unit. Vibrations of rocker 19 and sliding piece 15 or corresponding measured values can be registered by means of the acceleration sensor 25.

FIG. 2 shows a current collector 26 having a conductor rail 27, whereas in contrast to the current collector and the conductor rail of FIG. 1, a sliding piece 28 is disposed on a rocker 29 in such a manner that conductor rail 27 is contacted by sliding piece 28 from below. Thus, a spring device 30 of a contact pressing device 31 acts in the opposite direction. Furthermore, a sensor 32 is intended here by means of which an angular position of an angle α of rocker 29 is measured relative to a vertical mounting plane 33 of current collector 26. Thus, an information regarding a relative position of conductor rail 27 to the rail vehicle can be determined by means of a measured value or a measured angle. Sensor 32 is part of a sensing device (not further illustrated) of a measuring unit.

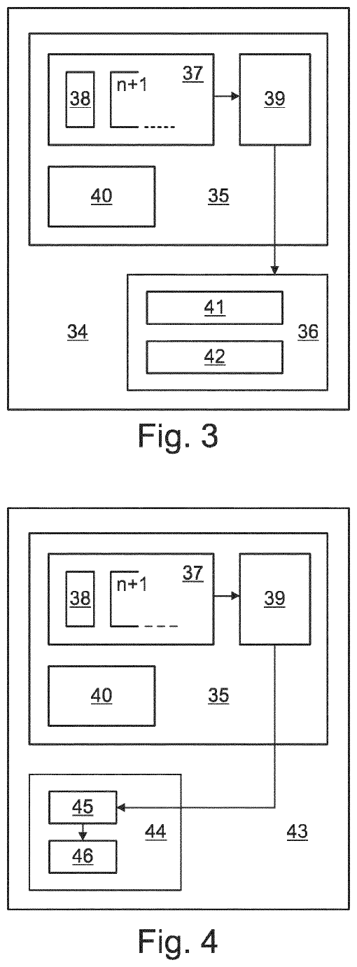

FIG. 3 is a schematic view of a first embodiment of a measuring unit 34. Measuring unit 34 is formed by a measuring device 35 and further comprises an evaluation unit 36. Measuring device 35 comprises a sensing device 37 having a plurality of sensors 38 and a processing unit 39. Furthermore, a supply unit 40 is intended by means of which measuring device 35 is supplied with electrical energy. Supply unit 40 can be an energy storage, a generator or an external energy supply, for example via a rail vehicle or a conductor rail. Evaluation unit 36 has a database 41 and an evaluation device 42 and receives data or measured values and/or parameters from processing unit 39. Processing unit 39 receives measured values from sensor 38 of sensing device 37 and processes them. The measured values relate to operating parameters or physical measured values of a contact pressing device of a current collector (not illustrated) in the manner of the current collectors which are illustrated in an exemplary manner in FIGS. 1 and 2. Processing unit 39 processes the measured values in such a manner that a parameter is determined which describes an operating state of the respective current collector and/or a conductor rail. The respectively determined parameters are transmitted consecutively or successively from processing unit 39 to evaluation unit 36 and are stored there in database 41 or are processed using evaluation device 42.

FIG. 4 shows a further measuring unit 43 in which, in contrast to the measuring unit of FIG. 3, processing unit 39 transmits data to a control device 44. Control device 44 is formed by a control mechanism 45 and a rocker unit 46, control mechanism 45 controlling an actuator (not further illustrated) of rocker unit 46 in accordance with the transmitted data. Thus, a contact pressing force of a sliding piece of a current collector, which comprises rocker unit 46, is controlled such by means of control mechanism 45 that the sliding piece can mostly be prevented from lifting off the conductor rail.

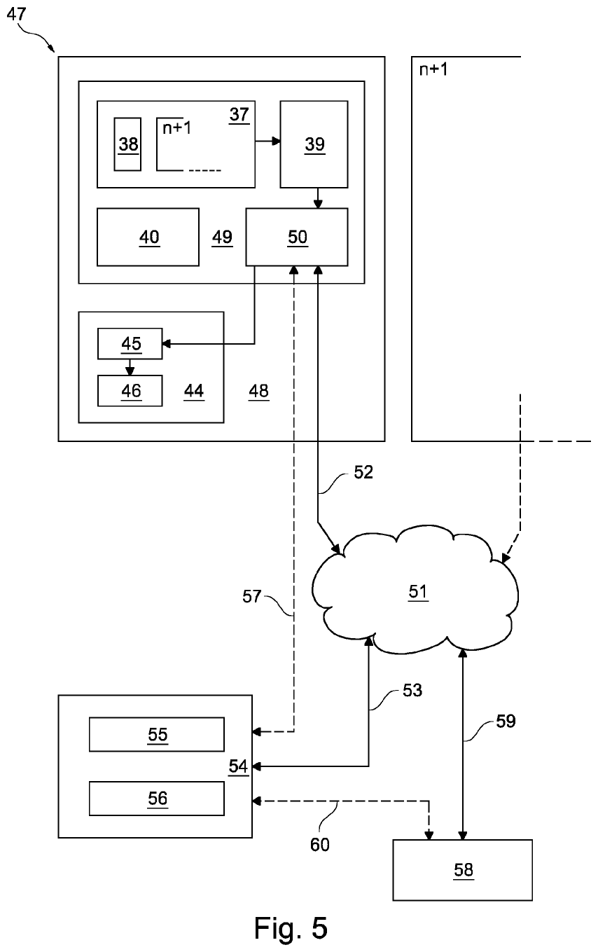

FIG. 5 shows a monitoring system 47 having a measuring unit 48. Monitoring system 47 can have a plurality of measuring units 48. In contrast to the measuring unit of FIG. 4, measuring unit 48 has a measuring device 49 which comprises a transmitting unit 50. Transmitting unit 50 receives data or measured values and/or parameters from processing unit 39 and transmits them to control device 44. Furthermore, a data link 52 by means of which measured values and/or parameters are transmitted using radio signals exists between transmitting unit 50 and an external data network 51. An evaluation unit 54 having a database 55 and an evaluation device 56 is connected to external data network 51 via another data link 53 and exchanges data or measured values and/or parameters with transmitting unit 50 via external data network 51. In principle, this data can be exchanged directly via a direct data link 52 while bypassing external data network 51. Furthermore, a user unit 58, which is connected to external data network 51 via another data link 59, is provided. Thus, user unit 59 can exchange data with evaluation unit 54, meaning that data of measuring unit 48 processed by evaluation unit 54 can be output or illustrated via user unit 58 and provided for further use. User unit 58 can be directly connected to evaluation unit 54 via a direct data link 60. Overall, it thus becomes possible to obtain measured values via sensors 38 which are mounted on current collectors (not illustrated) and to use them for directing controlling or regulating the respective current collector by means of control device 44. Furthermore, this data can be transmitted to evaluation unit 54 for storage and evaluation via external data network 51, for example the internet. Thus, functional dependencies of the data can be used, evaluated and interpreted. The results of these evaluations can be provided to an end user via user unit 58.

1-16. (canceled)

17. A current collector for transferring energy from a conductor rail to a rail vehicle, the current collector comprising:
a contact pressing device having a sliding piece forming a sliding contact surface, the contact pressing device including a rocker unit adapted for generating a contact pressing force using a pivotable rocker and a spring device, the sliding piece being disposed on the rocker, the contact pressing device being adapted to move the sliding piece relative to the conductor rail, for forming a sliding contact, and press the sliding piece against the conductor rail in a sliding contact position using the contact pressing force;
a measuring unit having a measuring device, wherein at least one sensor of a sensing device of the measuring device being disposed on or adjacent to the contact pressing device, whereby a measured value of the contact pressing device is registerable by means of the sensing device, the measured value being processable by means of a processing unit of the measuring device and a parameter describing an operating state of the current collector and/or the conductor rail being determinable.

18. A monitoring system having at least one rail vehicle having at least one current collector according to claim 17.

19. The monitoring system according to claim 18, in which
the monitoring system comprises a plurality of measuring units and an evaluation unit for processing measured values and/or parameters of the measuring units of a plurality of current collectors.

20. The monitoring system according to claim 18, in which
the monitoring system comprises a plurality of rail vehicles, each having at least one current collector.

21. A method for operating a current collector for transferring energy from a conductor rail to a rail vehicle, comprising:
moving a sliding piece of a contact pressing device relative to the conductor rail and pressing the sliding piece against the conductor rail using a contact pressing force;
registering, by a sensing device, a measured value of the contact pressing device;
processing, by a processing unit, the measured value; and,
determining, by the processing unit, a parameter describing an operating state of the current collector, the conductor rail, or the current collector and the conductor rail.

22. The method of claim 21, including continuously or discontinuously registering and processing at least one of the following as the measured value: an angular position of the rocker, an acceleration, a frequency, a temperature, an illuminance, a force, a current, a voltage, an electrical resistance, a distance, a mass, an air pressure, and a location.

23. The method of claim 21, including using at least one acceleration sensor, disposed on the sliding piece or a rocker unit carrying the sliding piece, as the sensory device.

24. The method of claim 21, including registering and storing, by the processing unit, the measured value received from the sensing device either (a) at regular time intervals, (b) when a change in the measured value occurs, or (c) continuously.

25. The method of claim 21, including controlling, by a control device, an activator for activating a rocker unit carrying the sliding piece, in response to (a) the measured value, (b) the parameter, or (c) the measured value and the parameter.

26. The method according to claim 21, including controlling, by the control device, the contract pressing force in response to (a) the measured value, (b) the parameter, or (c) the measured value and the parameter.

27. The method according to claim 21, including transmitting (a) the measured value, (b) the parameter, of (c) the measured value and the parameter to an evaluation unit, storing (a) the measured value, (b) the parameter, or (c) the measured value and the parameter in a database of the evaluation unit and processing (a) the measured value, (b) the parameter, or (c) the measured value and the parameter in an evaluation device of the evaluation unit.

28. The method of claim 27, including using a data link for the transmitting of (a) the measured value, (b) the parameter, or (c) the measured value and the parameter by a transmitting unit.

29. The method of claim 28 including forming the data link via an external data network.

30. The method of claim 28, including forming the data link by a user unit, whereby (a) the measured value, (b) the parameter, or (c) the measured value and the parameter are transmitted and output to the user unit.

31. The method of claim 27, including evaluating a time curve of (a) the measured value, (b) the parameter, or (c) the measured value and the parameter with the processing unit or the evaluation unit and determining a state of wear (i) of the current collector, (ii) the conductor rail, or (iii) the current collector and the conductor rail taking into account a time-dependent component, a component depending upon measurable variables relevant for the wear or both.

32. The method of claim 31, including registering a vibration of the sliding piece by the sensing device, determining (a) an eigenfrequency, (b) a resonant frequency of the sliding piece and the rocker unit or (c) both by the processing unit and determining a state of wear of the sliding piece by the processing unit or the evaluation unit.

33. The method of claim 32 including carrying out a pattern analysis of (a) the measured value, (b) the parameter, or (c) the measured value and the parameter stored over a time period and deriving a key figure from the pattern analysis by the processing unit or the evaluation unit.

34. The method of claim 27 including correlating (a) the measured values of different sensors, (b) the parameters, or (c) the measured values of the different sensors and parameters and deriving functional dependencies of (a) the measured values, (b) the parameters, or (c) the measured values and the parameters by the processing unit or the evaluation unit.

35. The method of claim 27, including determining, by a position sensor, a location of the current collector wherein the location is associated to the parameters and determining a state of wear of the conductor rail by the evaluation unit.

36. The method of claim 27, including processing the parameters of measuring units of a plurality of current collectors by the evaluation unit.
